(19) United States
(12) Patent Application Publication
(10) Pub. No.: US 2008/0132188 A1
(43) Pub. Date: Jun. 5, 2008

(54) Pico-Cell System for Wireless Access Having Micro Climatic Control Combined with Pay Telephones for Data Communication Installations in Harsh Environments

(76) Inventors: Robert Victor Nino, Newbury Park, CA (US); Scott Murdock, Seattle, WA (US)

Correspondence Address: GLENN PATENT GROUP, 3475 EDISON WAY, SUITE L, MENLO PARK, CA, 94025, US

(21) Appl. No.: 11/855,675

(22) Filed: Sep. 14, 2007

Related U.S. Application Data
(63) Continuation-in-part of application No. 10/400,294, filed on Mar. 25, 2003, now abandoned.
(60) Provisional application No. 60/369,450, filed on Apr. 1, 2002.

(51) Int. Cl. H04B 1/18

(52) U.S. Cl. 455/187.1

(57) ABSTRACT

A pico-cell wireless radio system, that has a pico-base transceiver station (pico-BTS), for wireless data communication within a climate controlled micro-environment is disclosed. The system fits in public phone enclosures, such as pay phone enclosures, and operates in combination with the phone system. The system uses a combination of available telephone and multiple low-power wireless data communication technologies, such as cellular, WiFi, and WiMax, to provide public access to communication networks, including wide area networks and local area networks. Placing the pico-cell based wireless system within a climate controlled chamber enables its use in harsh environments, as are typically to be expected where the public telephones are installed.

### CROSS REFERENCE TO A RELATED APPLICATION

This application is a continuation-in-part of U.S. patent application Ser. No. 10/400,294, filed Mar. 25, 2003, and which is incorporated herein in its entirety by this reference thereto.

### BACKGROUND OF THE INVENTION

1. Technical Field

The invention relates to the operation and installation of wireless communication systems in harsh environments.

2. Discussion of the Prior Art

The demand for wireless communication is growing at a very fast pace. As a result, spectrum resources are stressed by the growth in the volume of data and content transmitted over the spectrum that is available for allocation. Ideas such as that of an open system architecture are being floated to take care of this growing need for communication.

In the past, phone systems bore a large share of the data and voice communication needs over public switched telephone networks (PSTN). Public call installations have existed in high traffic areas that provide telephone communication access to the general public. These areas are typically in the open and have difficult environmental and usage conditions. The introduction and popularization of cell phones have greatly reduced the use of the existing PSTN facilities, both in public access areas, such as pay phones, and in the office and home environment. Yet these facilities exist even now with low overall usage.

The development of the xDSL modem that enable simultaneous transmission of voice and data over phone networks allows Internet connections through the same phone link. Similarly, WiFi, and WiMax wireless capabilities have been developed and can be used to provide access in local area networks (LAN), with an ultimate connection to a wide area network (WAN) or the Internet using the un-regulated spectrum.

It is also possible to use a cable modem, instead of an xDSL modem, for the transmission access over PSTN, although the invention herein is explained in connection with the use of xDSL.

If these facilities could be used to provide wireless access for the public to communication networks, including wide area networks and local area networks, the problem of high spectrum usage leading to congestion and availability issues would be at least partially alleviated.

### BRIEF DESCRIPTION OF THE DRAWINGS

FIG. 1 is a block diagram showing the inventive public communication access system;

FIG. 2 is a block diagram of a public communication access system, including an environmental block for wireless data access to improve robustness, according to the invention;

FIGS. 3A and 3B provide a connection diagram of a wireless data access system according to the invention; and

FIGS. 4A and 4B provide a diagram showing a micro-environmental system for a wireless data access system according to the invention.

### DETAILED DESCRIPTION OF THE INVENTION

A pico-cell wireless radio system for wireless data communication comprises a pico-base transceiver station (pico-BTS) that is maintained within a climate controlled micro-environment which fits in public phone enclosures, such as a pay phone enclosure. The system operates in combination with the phone system and uses a combination of available telephone and multiple low-power wireless data communication technologies, such as cell phones, WiFi, and WiMax, to provide public access to communication networks, including wide area networks and local area networks. Placing the pico-cell based wireless system within a climate controlled chamber enables its use in harsh environments, as is typically to be expected where the public telephones are installed.

High speed wireless data connectivity, which does not further tax the available spectrum, can be achieved by using a combination of multiple wireless capabilities with existing public phone facilities for data connections. A limiting factor that exists in achieving such connectivity, in addition to the capabilities of the various wireless transmit-receive systems such as WiFi, and WiMax, is the need for environmentally robust and low power radios that use a pico-cell or pico-base transceiver station (pico-BTS). In a number of areas, public access phones are exposed to harsh environments produced by the climate changes. This can increase failures of radio systems and, in turn, result in low reliability of such systems. The invention comprises a micro climate control system that provides a stable temperature and humidity environment for the pico-cell system to overcome this problem.

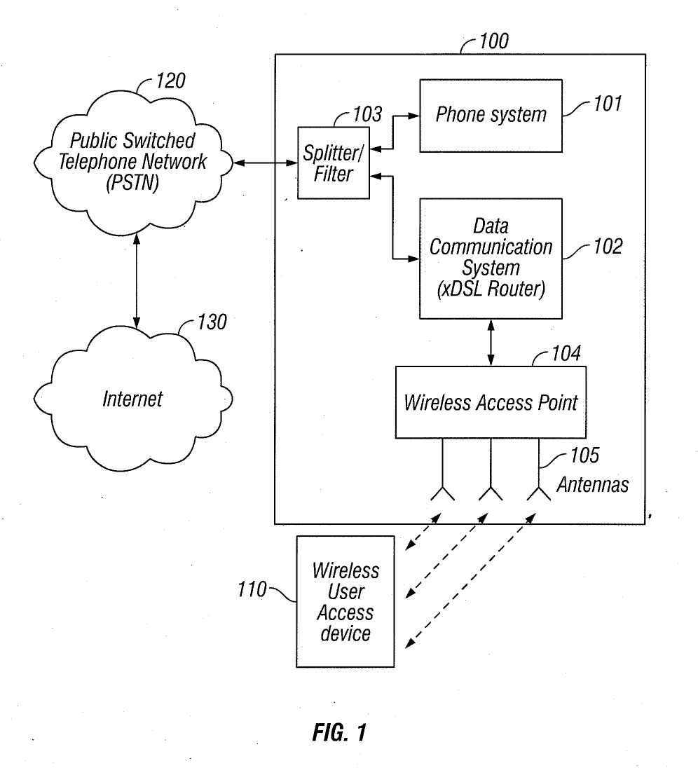

FIG. 1 shows an exemplary implementation of the inventive communication access system. The public communication access system 100 typically comprises a voice communication access portion and a wireless data communication access portion. The terms “data” and “data communication” as used herein should be understood to include, without limitation, voice, video, text, email, computer programs, script files, documents, messages, attachments, and any other kind of digital information capable of being communicated. Typically, the wireless data communication access system comprises the wireless access system and the back haul and filter to a PSTN network. In the exemplary implementation, analog voice communication is handled by the public telephone system 101. In the preferred embodiment, the digital voice and data are handled by the data communication system 102 using the xDSL protocol. A splitter 103 combines/separates the analog voice and the digital data at the connection to the PSTN network 120. The PSTN network can be a used as a LAN network and it also acts as the back haul connection to the WAN Internet cloud 130. The data is received and transmitted from the user access device 110 at the wireless access point 104 through the antennas 105 in the public communication access system. Transmission can be accomplished by either wireless cell phone or data communication devices using communication spectrum, WiFi, or WiMax connectivity. Typically, the wireless access point comprises a pico-BTS radio that is capable of receiving the transmitted information. The use of a pico-cell radio allows the system to be localized with low power dissipation, thus providing a public access location or hot-spot within and around the public communication access point.

Another operational method, not shown in FIG. 1, provides a connection through the PSTN for the communication access system to a private LAN network that is connected to the Internet. The LAN network can, in a selective fashion, provide WAN or Internet access. This configuration can be used to provide multiple levels of access control for communication.

Typical prior art public call phone systems are located in high traffic areas that may be subjected to harsh environmental conditions. Prior art telephone subsystems are capable of handling these adverse conditions. The pico-cell systems disclosed herein, on the other hand, are precision wireless systems that may not have be designed for such harsh environments. Use of these systems in such environments can adversely affect their functionality and operation and, thus, make them unreliable. The use of controlled micro environment within which the pico-cells are deposed is disclosed herein. This expedient enables such systems to be reliable and consistent and work in all environmental conditions without degradation of performance.

In the preferred embodiment, an existing public telephone 101 has a PSTN loop 120 that provides communication network access, as well as voice access. In a typical implementation of the invention, an xDSL router/modem 102 is connected to the telephone's local loop and provides Internet access. A well known pass filter/splitter 103 is used to provide the necessary isolation between the voice loop and the data loop for simultaneous operation of both. In a typical set up, WiFi or WiMAX wireless transmission provides wireless data access to the pico-BTS radios at the wireless access point by means of antennas 105. It is simple, easy, and inexpensive to implement a micro-environment to provide the radios and critical data communication system with the robustness necessary to withstand environmental variations and to provide stable and reliable service.

There exist several advantages to this robust system when it is implemented as described herein:
1. This implementation enables data and voice access through existing infrastructure available in most public locations;
2. The scarcely used facilities of the public phones are again used for providing public access to voice and data communication;
3. The system does not stress the controlled and congested wireless spectrum;
4. The cost of implementation of the communication system is lower due to the use of existing, depreciated facilities;
5. The system is based on internationally accepted technology and standards, such as WiFi and WiMAX, for local access to the access point;
6. Public acceptance of the system is likely due to its reliable and robust operating characteristics; and
7. The public access communication system is capable of providing simultaneous voice and wireless data access to the public.

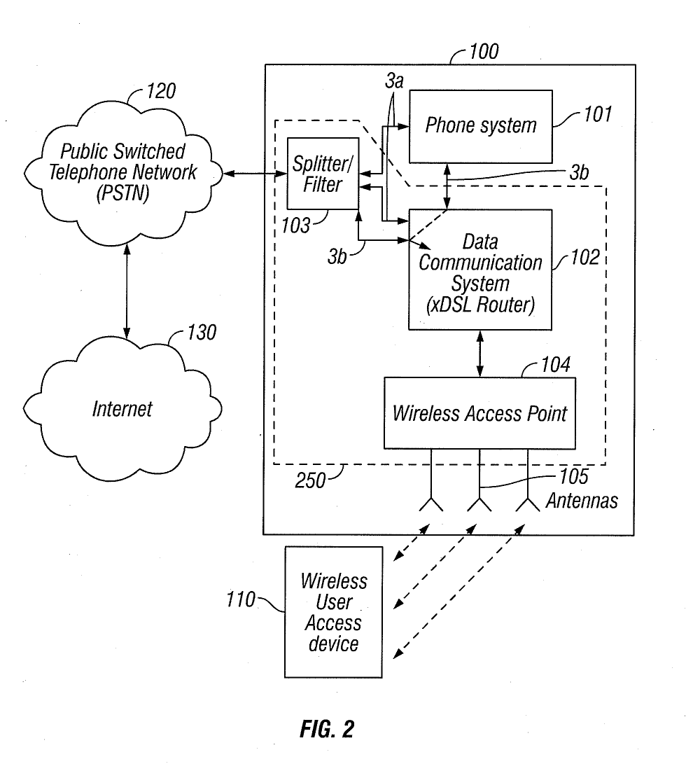

FIG. 2 shows a typical installation of the micro-environment 250 to provide the robustness to the wireless data access system. All the critical components of the wireless data communication system are enclosed within a climate controlled micro-environment. Typically, each of the critical components that impacts the robustness and reliability is in a climate controlled micro-chamber. The use of micro-chambers reduces the volume of area that must be climate controlled and, hence, the power requirements and cost of operation.

FIG. 2 shows one of the preferred embodiment of the invention. The public communication access system 100 is comprised of a unique and inventive combination of components that provide a robust system. One feature of this embodiment is that it provides public wireless access to communication networks, such as the Internet 120, through existing and new PSTN facilities 130. This includes all forms of communication, for example, voice and computer data. Telephone equipment is connected to the PSTN network 130 to enable the placing of calls or interconnecting to Internet 120. Public pay telephones 101 are an example of such usage. Such pay telephones 101 are placed in public locations to provide public access to the PSTN 130 for a fee. These PSTN connections typically include at least a local access loop. Typical placement of such public telephones is in an area of high traffic, and includes environmentally harsh areas. Hence, providing a climate controlled environment 250 for the components of the wireless access system allows enhanced operational stability for the total communication access system 100.

In the preferred embodiment, an optional splitter/filter 103 is connected between the PSTN 130 and the pay telephone equipment 101. The splitter/filter 103 provides the telephone and the wireless data communication equipment 102 within the communication access system 100 with one or more filtered connections to the PSTN. The splitter/filter 103 supports simultaneous access to the PSTN and network systems, such as the Internet, across the same PSTN local loop facility. The splitter/filter 103 also suppresses interference between the voice and data signals.

Optionally, plain old telephone system (POTS) splitters are provided to allow the telephone local loop to be used for simultaneous high speed digital subscriber line (DSL) or the advanced xDSL transmission. Such POTS filters can be active or passive filters. A typical implementation uses an off the shelf, standard passive filter or microfilter as the splitter/filter 103.

In another embodiment, the splitter/ filter integrated into the subsystem of the xDSL modem/router 102. In this embodiment, the xDSL modem/router 102 is connected to the PSTN 130 facility and passively connected to the telephone equipment 101. Reference numeral 3a in FIG. 2 represents a separate in line filter connection for the splitter/filter 103, while reference numeral 3b shows the data flow for an integrated filter/splitter 103 that is integrated with the modem/router 102.

In the embodiment of the invention shown in FIG. 2, the xDSL modem/router 102 constitute data communication equipment that passes data received at the wireless access point 104 to the PSTN 130. Other embodiments of the invention use alternate communication equipment, such as a cable modem, for the connection of the wireless access point 104 to the PSTN 130. The wireless access point 104 can be of the type conforming to WiFi or WiMAX standards. The wireless access point connects the antennae 105 to the data communication equipment for wireless transmission and reception. Some or all the components of the wireless communication system my be combined into a single unit or subsystem, if desired. The specific types of antennae 105, access point 104, and modem/router 102 are preferably selected to provide the best possible service within the environmental and coverage constraints of the public communication access system.

The invention thus provides a public communication access system 100 that has both telephone voice capability and wireless data communication capability provided by the data communication equipment 102, the wireless access point 104, and the antennae 105, all of which are connected to the Internet 120 through a splitter 103 and the PSTN 130 network. Even though a public communication access system is disclosed herein, it is not necessary for the system to be public. It can be implemented as a private or shared communication system if desired.

The communication access system 100 also provides the capability for user authentication, access control, and security implementations that are necessary for users to connect to communication networks. These form a part of the disclosed invention.

A typical access process using an embodiment of the disclosure involve the following steps:
Step 1. The user's wireless device 110 requests a connection from an available access point 104.
Step 2. The user is presented with an authentication/validation protocol to follow on his wireless device.
Step 3. The user enters the appropriate sequence of actions for validation and billing information.
Step 4. The user is granted access to the network, and appropriate billing tracking processes are engaged.
Step 5. The user employs such access to transact his business and/or transmits and receives information.
Step 6. The user disconnects from the network, the billing process is completed, and appropriate charges are levied.

By use of the disclosed invention, individuals with wiFi and WiMax enabled user devices 110 can access the Internet. The user devices 110 may include, but are not limited to, personal computers, personal digital assistants (PDA), telematics devices, and Voice over IP (VoIP) devices.

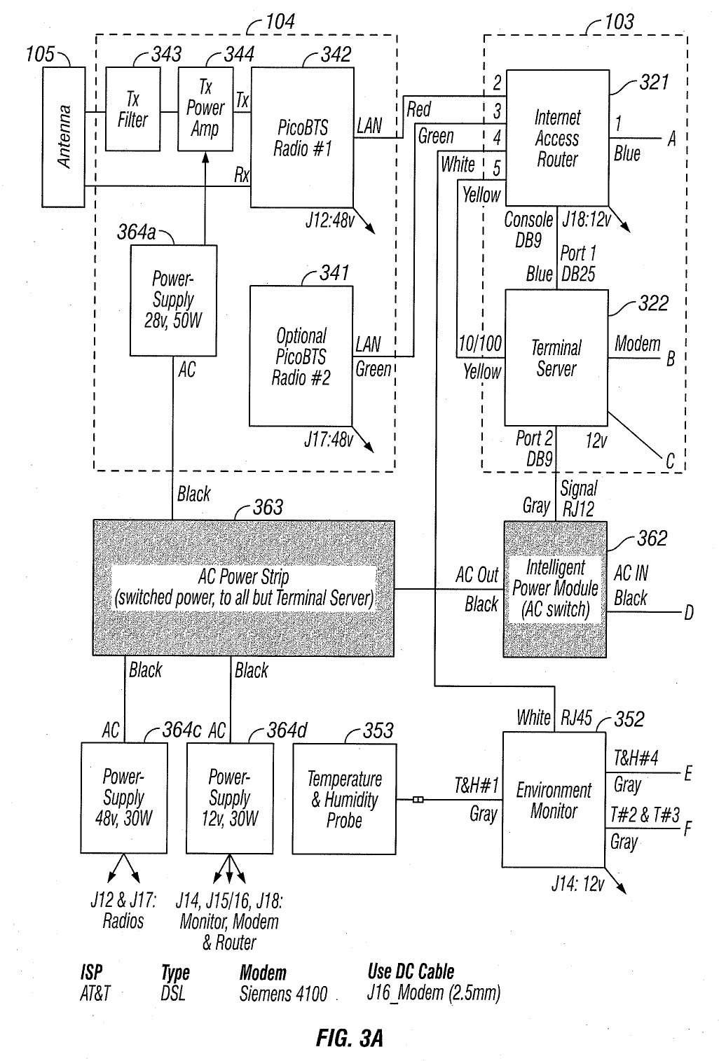

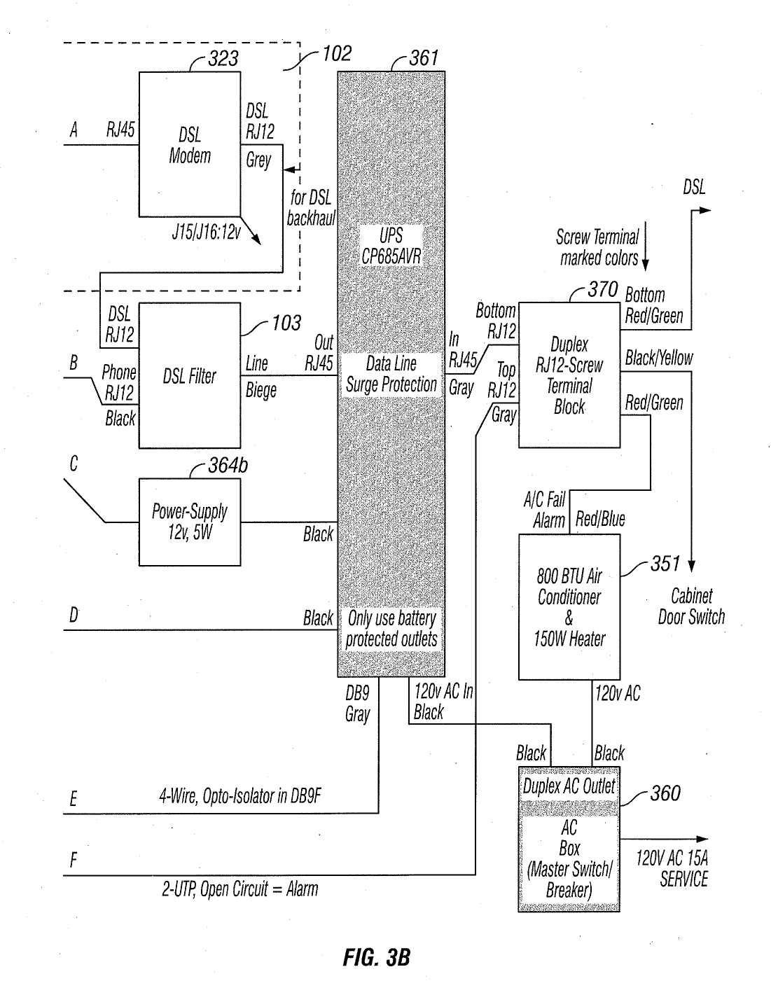

FIGS. 3a and 3b provide an exemplary implementation of the wireless access system showing its components, including the power supplies; the antenna 105; the wireless access point 104 comprising the dual pico-BTS 341 and 342, the transmit filter 343, the power amplifier 344; the DSL based communication system 102 comprising the Internet access router 321, terminal server 322, and DSL modem 323. The filter 103 is the last major component of the wireless system. The filter separates the voice signal from the data to prevent interference between the two components of the communication system. An environmental system providing a typical capacity of 800 BTU air-conditioning (A/C) or 150 W heater capacity 351 with a monitoring block 352 and probes 353 is included for environmental control for improved robustness, as disclosed above. A power supply system with input power from terminals 360 with uninterrupted power supply 361 and an intelligent power switch 362 supplying power to a power strip/distribution box 363 is also shown. The individually controlled power supplies to the various sub-blocks 364a to 364d are derived from the distribution box 363. A protection and safety controlled terminal block 370 is used to connect the DSL line to the external PSTN line.

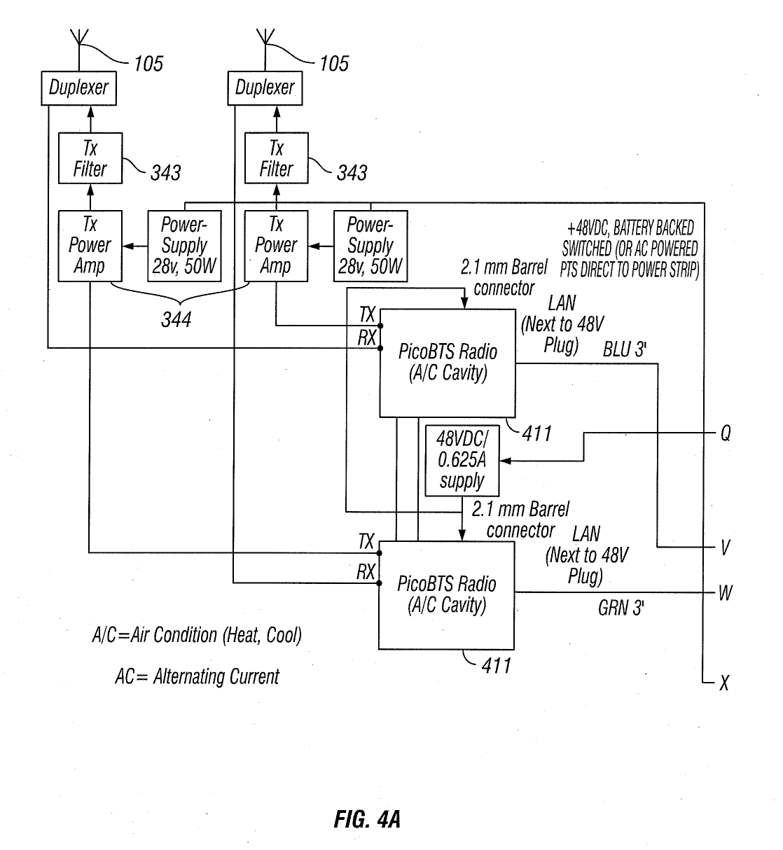

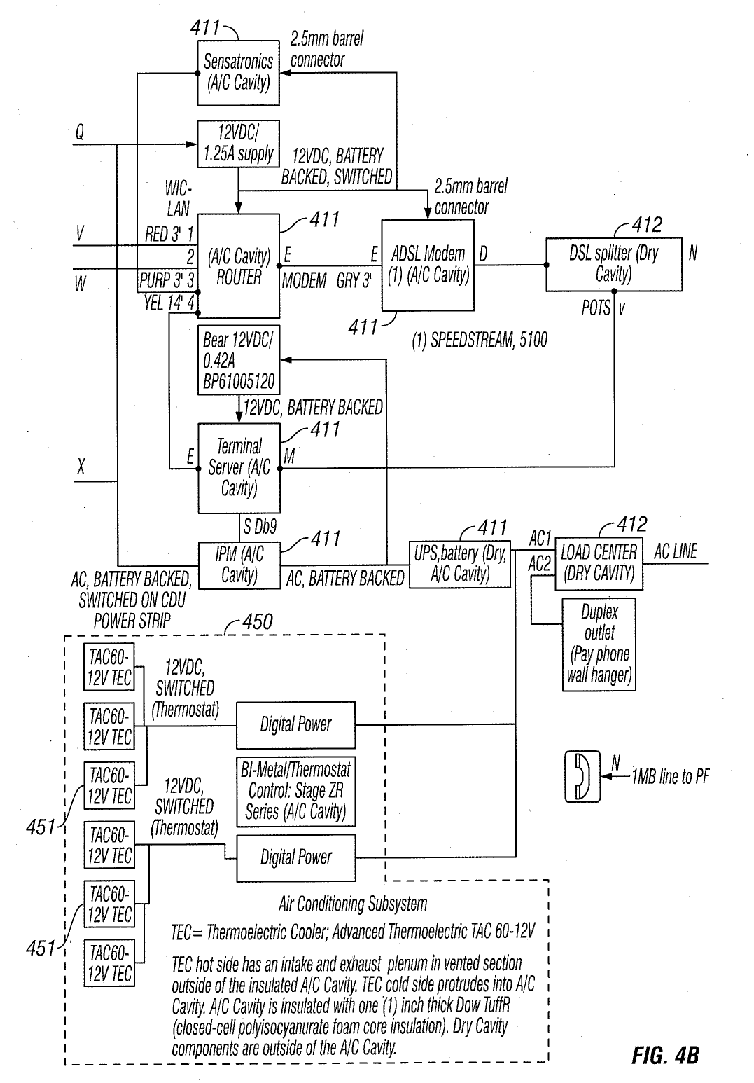

FIGS. 4a and 4b show the details of an exemplary and non-limiting implementation of an environmental block that is adapted for reduced power consumption. Individual air conditioned micro-chambers 411 or dry micro-chambers 412 are used for each element of the wireless communication system to reduce the cavity size and, hence, the power required to provide stable environment. A typical implementation comprises a thermoelectric cooler 451 using a TA-60 thermoelectric cooler, as shown in the air conditioning subsystem 450. The thermoelectric cooler/heater operates by transferring heat from a cold side to the hot side when power is applied. The heat from the hot side is removed by convection or other means for the cooling operation to be effective. The same principle can be used to heat the micro-chamber 411. Hence, the micro-environment provides both cooling and heating capability for maintaining stable temperature conditions within the cavities during adverse conditions. Typically, this is achieved by changing the supply of heating or cooling for the micro-chambers 411.

In the implementation shown, a TEC hot side has an intake and exhaust plenum in a vented section that is outside of the insulated A/C cavity. The TEC cold side protrudes into the A/C cavity. The presently preferred A/C cavity is insulated with closed-cell polyisocyanurate foam core insulation. Dry cavity 412 components are outside of the A/C cavity.

Use of the environmental chamber with the communication system for voice and wireless data, as described for example in FIG. 1, provides a very robust and efficient system for public access. Environmentally harsh locations, where public phone booths are available, can be easily and efficiently used with such environmentally stabilized installations. Hence, the reliability and use of the system is vastly improved. This provides a feasible and profitable system for public access in all conditions and environments.

In the exemplary embodiment, the telephone voice and wireless data connections exist simultaneously in an operating public phone enclosure. It is possible to use the connectivity available to PSTN for wireless data communication access alone, without providing telephone access.

The disclosure also can be scaled easily. In places where the demand is high, wireless access can be scaled by connecting multiple wireless access points and data communication equipment. The public communication access system 100 of the disclosure can be scaled and configured to accommodate simultaneous access by multiple customers.

In another embodiment, the capability to cater to different bandwidth requirements is provided. The wireless access equipment can easily be configured to cater to low or high bandwidth requirements, e.g. low bandwidth for email and similar applications, and high bandwidth for video applications.

Even though the disclosure is oriented towards using payphones with wireless equipment installed as the base with voice and data capability, it is possible to use other base structures to implement the invention, such as existing kiosks for other applications, as long as there is the capability to connect to the Internet directly.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An environmentally robust, public access communication system for both voice communication and data communication, comprising:
a public switched telephone network (PSTN) interface connected to the PSTN for access to a data network;
a public telephone connected to the PSTN for voice communication;
a wireless data communication access system connected to the PSTN via the PSTN interface for data communication;
a filtering unit for separation of data communication from voice communication;
a micro-climate unit for providing a micro-environment for at least one component of the communication system, said micro-environment adapted to maintain robustness and reliability of said at least one component of the communication system when said at least one component is subjected to harsh environmental conditions, said a micro-climate unit providing public telephone access for public use of the communication system for both voice communication and data communication; and
the communication system adapted to use an existing PSTN for said voice communication and for data network access to any of a wide area network (WAN) or a local area network (LAN) for said data communication.

2. The communication system of claim 1, further comprising:
means for providing simultaneous voice and data communication.

3. The communication system of claim 1, further comprising:
data communication equipment connected through the PSTN to the Internet for wireless data communication access.

4. The communication system of claim 3, said data communication equipment comprising:
a xDSL modem for providing simultaneous voice communication and data communication.

5. The communication system of claim 3, said data communication equipment comprising:
a cable modem for providing simultaneous voice communication and data communication.

6. The communication system of claim 1, said micro-environment further comprising:
heating and/or cooling means for providing a stable operating temperature for said at least one component of the communication system.

7. The communication system of claim 1, said micro-environment further comprising:
at least one thermoelectric cooler for controlling said micro-environment.

8. The communication system of claim 6, said heating and/or cooling means comprising:
at least one micro-chamber in which said heating or cooling is performed;
wherein a micro-chamber is provided for each component that requires a stable environment for robust operation.

9. The communication system of claim 8, said at least one micro-chamber comprising:
means for reducing power required to achieve and maintain said stable environment.

10. The communication system of claim 1, comprising:
means for data communication access to a LAN network through the PSTN.

11. The communication system of claim 10, comprising:
means for selective connection to a WAN via said LAN network.

12. The communication system of claim 1, said LAN comprising:
a private LAN network.

13. A public access communication system, comprising:
means for using an existing public switched network (PSTN) for both voice and data communication;
a wireless data communication system for providing wireless data connectivity for said data communication; and
at least one micro-chamber comprising a climatic control, said at least one micro-chamber adapted to enclose at least one communication system component therein;
wherein said climatic control is adapted to maintain robustness and reliability of said at least one component of the communication system when said at least one component is subjected to a wide range of environmental conditions.

14. The communication system of claim 13, said wireless data communication system comprising,
at least one pico-base transceiver station (pico-BTS) radio for low-power dissipation.

15. The communication system of claim 14, said at least one micro-chamber comprising:
means for reducing power required to achieve and maintain a stable environment.

16. A public access communication system for both voice and wireless data communication, comprising:
a wireless communication system connected to an existing public switched network (PSTN) through a filter, the wireless communication system adapted to avoid use of crowded public spectrum when providing wireless access to said PSTN;
a router/modem connected to said filter for data transmission;
a wireless access point, connected to said router/modem for transmission and reception of wireless signals using any transmission-reception scheme from the group comprising WiFi and WiMax;
a plurality of antennae connected to said wireless access point for receiving and transmitting said wireless signals; and
means for enclosing at least one component of said communication system in at least one micro-chamber, said micro-chamber comprising a climatic control that is adapted to maintain robustness and reliability of said at least one component of the communication system when said at least one component is subjected to a wide range of environmental conditions.

17. The public access communication system of claim 16, said modem comprising:
an xDSL modem.

18. The public access communication system of claim 17, said modem comprising:
a cable modem.

19. A system for wireless data communication, comprising:
a pico-cell wireless radio (pico-BTS);
a micro-climate control for containing said pico-cell wireless radio (pico-BTS), said micro-climate control adapted for installation in a public telephone enclosure;
wherein said pico-cell wireless radio (pico-BTS) is adapted to operate in combination with a telephone system associated with said public telephone enclosure to public access to both voice and data communications facilities.

20. The system of claim 19, said micro-climate control further comprising:
a controlled micro-environment comprising thermoelectric coolers for establishing local air conditioning for individual modules of said pico-cell wireless radio (pico-BTS).
